(19) United States
(12) Patent Application Publication
(10) Pub. No.: US 2025/0205898 A1
(43) Pub. Date: Jun. 26, 2025

(54) COMMODITY TRANSFER APPARATUS AND CONTROL METHOD FOR SAME

(71) Applicant: TELEXISTENCE INC., Tokyo (JP)

(72) Inventors: Pavel SAVKIN, Tokyo (JP); Joni VAEAETAEINEN, Tokyo (JP)

(73) Assignee: TELEXISTENCE INC., Tokyo (JP)

(21) Appl. No.: 18/848,723

(22) PCT Filed: Mar. 24, 2023
(86) PCT No.: PCT/JP2023/011752

§ 371 Date: Sep. 19, 2024

(30) Foreign Application Priority Data
Mar. 29, 2022 (JP) 2022-052993
Jul. 25, 2022 (JP) 2022-117864

(51) Int. Cl. B25J 9/16

(52) U.S. Cl. CPC B25J 9/1697; B25J 9/163; B25J 9/1661

(57) ABSTRACT

According to one embodiment of the present disclosure, a product transfer apparatus is provided. The product transfer apparatus includes an arm unit having a holder unit for holding a product, an image capture unit for obtaining image data including at least a portion of the product held by the holder unit for placing the product on one of a plurality of lanes provided on a shelf plate of the product display shelf for displaying the product and placed above the one of the lanes by the arm unit, and at least a portion of the shelf plate including a position of the display, and a control unit. The control unit is configured to identify, based on the image data, a positional relationship in a direction in which the plurality of lanes are arranged, between a reference position of the lane for placing the product of the shelf plate, and the product placed above the lane, and correct, based on the identified positional relationship, the position of the product relative to the reference position by operating the arm unit.

### TECHNICAL FIELD

The present disclosure relates to a product transfer apparatus and a method of controlling the product transfer apparatus.

### BACKGROUND

JP2018-110755 discloses a product replenishment system which performs unmanned replenishment of products to reduce work labor. This product replenishment system includes an image capture device for capturing an image of a product as a target of replenishment, and a multi-joint robot apparatus for moving the product. The multi-joint robot apparatus picks up a product as the target of replenishment from a predetermined position where the product is placed beforehand, and moves the product to a product display shelf.

### SUMMARY

In the system described in JP2018-110755, in general, the position of the product display shelf recognized by the system through an image recognition technique, etc. may be different from the actual position of the product display shelf. When such a difference is present, if the multi-joint robot apparatus moves a product to place the product at a movement destination position on the product display shelf, the product will be placed at a position which deviates from the position on the product display shelf where the product is supposed to be placed. As disclosed in JP2018-110755, some product display shelves have partition plates which divide display lanes, and if a product is placed at a position where the product comes into contact with such a partition plate, the product will fall over.

An object of the present disclosure is to provide a product transfer apparatus, etc. which enables correction of the position of the movement destination of a product in the case where the position of the product is different from the intended position.

According to an aspect of the present disclosure, a product transfer apparatus configured to move a product placed on a stock shelf to a product display shelf which is different from the stock shelf is provided. The product transfer apparatus comprises: an arm unit having a holder unit configured to hold the product; an image capture unit configured to obtain image data including at least a portion of the product held by the holder unit for placing the product on one of a plurality of lanes provided on a shelf plate of the product display shelf for displaying the product and placed above the one of the lanes by the arm unit, and at least a portion of the shelf plate including a position of the display; and a control unit configured to control operation of the holder unit, the arm unit, and the image capture unit. The control unit is configured to perform: identifying, based on the image data, a positional relationship in a direction in which the plurality of lanes are arranged, between a reference position of the lane of the shelf plate on which the product is to be placed and the product placed above the lane; and correcting, based on the identified positional relationship, the position of the product relative to the reference position by operating the arm unit.

Other features and advantages of the present disclosure can be understood from the following description and the accompanying drawings which are given in an illustrative and non-comprehensive manner.

According to the present disclosure, a product transfer apparatus, etc. which enables correction of the position of the movement destination of a product in the case where the position of the product at the movement destination is different from the intended position is provided.

### BRIEF DESCRIPTION OF THE DRAWINGS

FIG. 1 is a plan view schematically showing the layout of shelves in a store and a product transfer apparatus provided in the store;

FIG. 2(a) is a view showing a product display shelf viewed from the front side, and FIG. 2(b) is a view showing the product display shelf viewed from the back side;

FIG. 3 is a side view schematically showing structure of the product transfer apparatus;

FIG. 4 is a perspective view showing structure around a front end of an arm unit of the product transfer apparatus;

FIG. 5 is a block diagram showing structure of the pr

FIG. 6 is an image of a product display shelf captured by a first camera (left side) of the product transfer apparatus;

FIG. 7 is a view showing an example of a capture image captured when a product held by a holder unit is moved to a position above a product placement position of a shelf plate of the product display shelf;

FIG. 8 is a flow chart showing replenishment operation of the product by the product transfer apparatus;

FIG. 9 is a flow chart showing a first operation example of the product transfer apparatus; and

FIG. 10 is a conceptual view showing examples of various positional relationships between a product held by the holder unit, and placed above the placement position before being placed at the placement position on the shelf plate, and the placement position on the shelf plate, captured by the second camera of the product transfer apparatus.

### DETAILED DESCRIPTION

Hereinafter, an embodiment of the present disclosure will be described with reference to the drawings.

### <Layout Structure of Store>

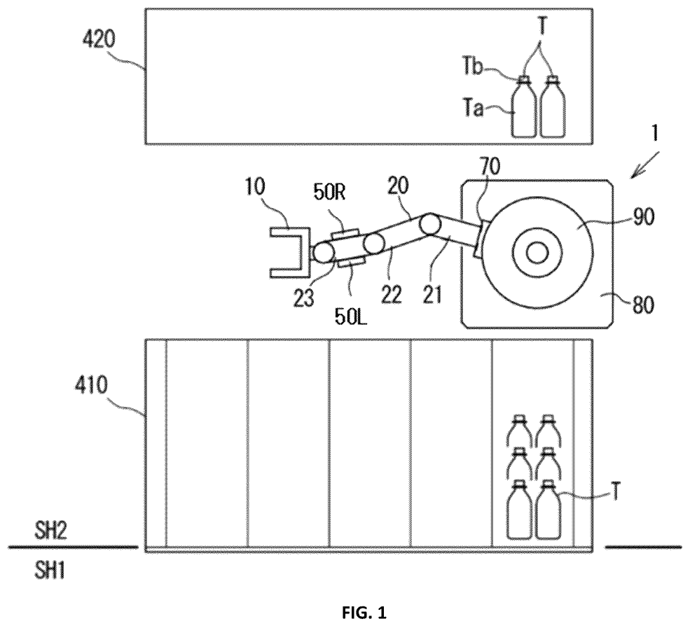

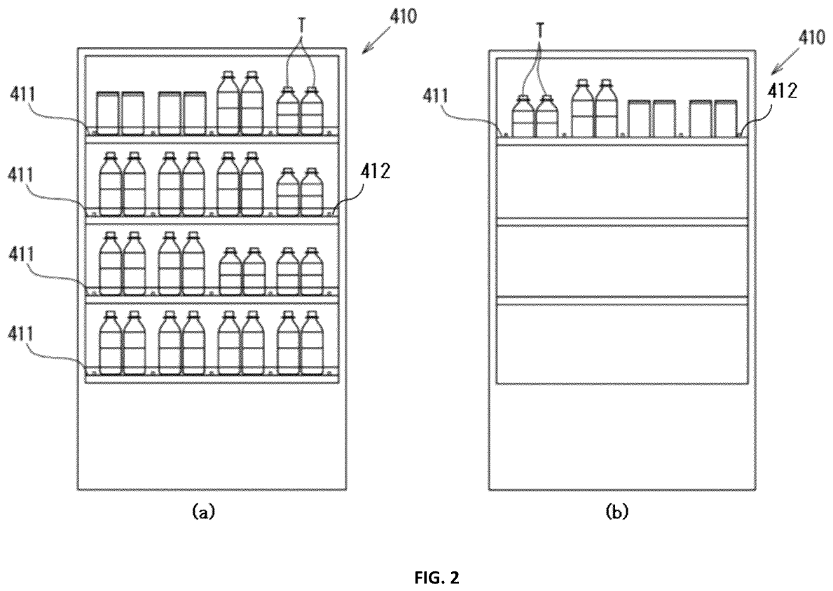

Firstly, layout structure of a store will be described. FIG. 1 is a plan view schematically showing the layout of shelves in a store and a product transfer apparatus provided in the store. FIG. 2(a) is a view showing a product display shelf viewed from the front side, and FIG. 2(b) is a view showing the product display shelf viewed from the back side.

As shown in FIG. 1, the inside of the store is divided into an in-store space SH1 and a backyard space SH2. The in-store space SH1 is a space where customers select and purchase products T. The backyard space SH2 is a space where the stock of the products T is stored. A product display shelf 410, a stock shelf 420, and a product transfer apparatus 1 are provided in the store.

As shown in FIGS. 2(a) and 2(b), the product display shelf 410 has a plurality of shelf plates 411 (also referred to as the levels of the product display shelves). A plurality of types of products T are placed on the shelf plate 411. For example, the products T of the same type are arranged in two rows or three rows. The products T may be arranged in only one row. A plurality of partition plates 412 dividing the products T arranged in each row are provided on the upper surface of each of the shelf plates. In FIG. 2, an example of products T of the same type arranged in two rows is illustrated, and in this example, a partition plate 412 is provided for every two rows of products T. The layout of the partition plate 412 is not limited to the above example, and the partition plate 412 can be arranged at intervals of one row or two or more rows.

The front side of the product display shelf 410 faces the in-store space SH1. So, customers can take products T from the front side of the product display shelf 410. The shelf plate 411 is inclined such that the front side gets lower relative to the back side. In the structure, when a customer takes a product T, other products T arranged behind the product T slide on the shelf plate 411, and move toward the front side.

The back side of the product display shelf 410 faces the backyard space SH2. So, a store employee or the product transfer apparatus 1 can replenish the product display shelf 410 with the products T from the back side of the product display shelf 410. Although not shown in the drawings, doors may be provided on the front and back sides of the product display shelf 410. In FIG. 1, though only one product display shelf 410 is drawn for simplicity of illustration, a plurality of product display shelves 410 may be provided in the store.

The stock shelf 420 is provided to face the product display shelf 410, and the front surface of the stock shelf 420 and the back surface of the product display shelf 410 face each other. As in the case of the product display shelf 410, the stock shelf 420 includes a plurality of shelf plates (levels) disposed in the height direction. Replenish target products as target products of replenishment for the product display shelf 410 are arranged on the shelf plate of the stock shelf 420. The replenishment target products may be arranged by a store employee, or the product transfer apparatus 1.

### <Structure of the Product Transfer Apparatus 1>

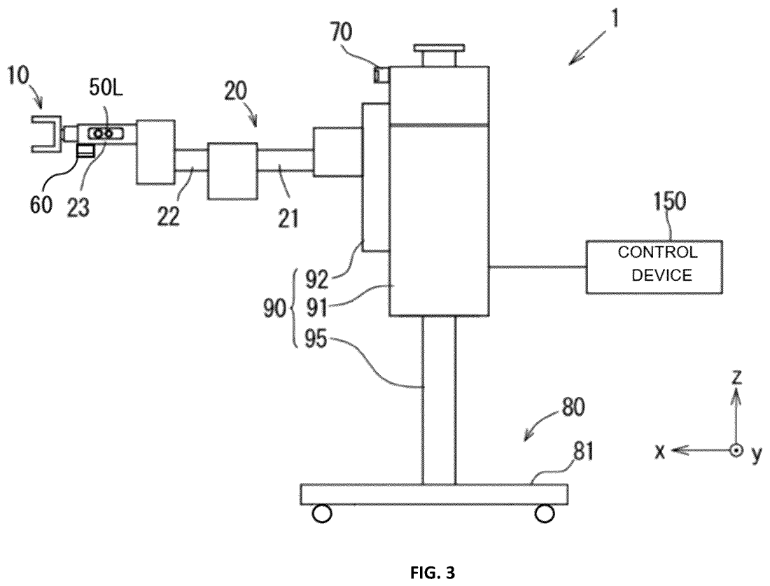

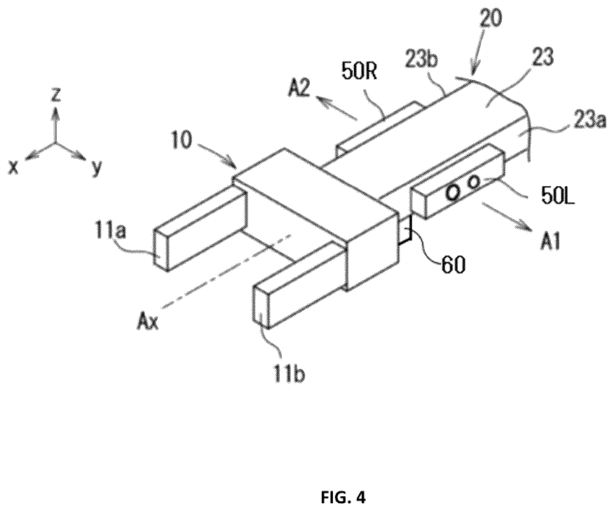

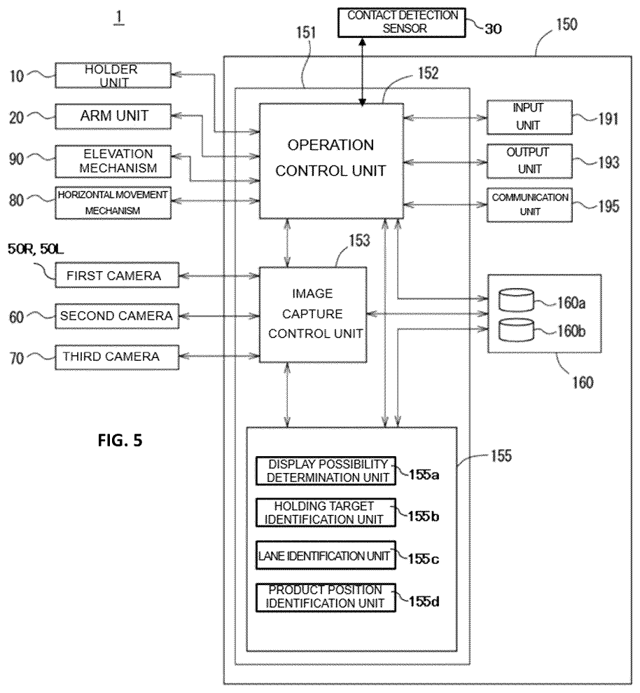

The product transfer apparatus 1 will be described with reference to FIGS. 1, and 3 to 5. FIG. 3 is a side view schematically showing structure of the product transfer apparatus 1. FIG. 4 is a perspective view showing structure around a front end of an arm unit of the product transfer apparatus 1. FIG. 5 is a block diagram showing structure of the product transfer apparatus 1.

The product transfer apparatus 1 includes a holder unit 10, an arm unit 20, a contact detection sensor 30, first cameras 50R, 50L, a second camera 60, a third camera 70, a horizontal movement mechanism 80, an elevation mechanism 90, and a control device 150. The product transfer apparatus 1 is a robot which moves in a space between the product display shelf 410 and the stock shelf 420. The product transfer apparatus 1 holds a product T in the stock shelf 420 by the holder unit 10, and thereafter, moves the product T held by the holder unit 10 to a display position of the product, of the product display shelf 410 (lane which displays the product T).

As shown in FIG. 4, the holder unit 10 includes a pair of holder members 11a, 11b for holding a target object. The pair of holder members 11a, 11b have a shape configured to hold the product T which is a PET bottle beverage at a position near the cap member Tb. Further, the pair of holder members 11a, 11b have a shape configured to hold an outer peripheral portion of the product T which is a canned beverage. The holder unit 10 may not be formed by the pair of holder members 11a, 11b. Alternatively, the holder unit 10 may be configured to hold a target object by adsorption or may be configured to hold a target object by using an adhesive force, a magnetic force, etc.

The arm unit 20 includes a plurality of link members 21, 22, 23. The plurality of link members 21, 22, 23 form a multi-joint robot arm. For example, the multi-joint robot arm may be a 6-axis arm with degrees of freedom in a straight direction along each of the X, Y, and Z axis directions, and with degrees of freedom in each of the directions about the X, Y, and Z axes. The multi-joint robot arm may have any other mechanism, such as an orthogonal coordinate system robot arm, a polar coordinate system robot arm, a cylindrical coordinate system robot arm, or a SCARA robot arm. One end of the arm unit 20 is fixed to the elevation mechanism 90. The holder unit 10 is provided at a front end of the arm unit 20. Operation of the arm unit 20 is controlled by the control device 150.

The arm unit 20 can move the holder unit 10 toward the stock shelf 420 or toward the product display shelf 410 by moving respective link members 21, 22, 23. The orientation of the arm unit 20 is not fixed to a certain direction. However, for the sake of explanation, the direction in which the respective link members 21, 22, 23 are extended will be referred to as the extension direction Ax of the arm unit 20 (see FIG. 4). The arm unit 20 moves the holder unit 10 forward toward the product T to hold the product T. The extension direction Ax of the arm unit 20 corresponds to the forward direction of the holder unit 10 in the holding operation.

The contact detection sensor 30 is a sensor which detects that the product T held by the holder unit 10, the holder unit 10 or the arm unit 20 contacts an obstacle such as a wall or a pillar of the product display shelf 410 at the time of placing the product T held by the holder unit 10 on the shelf plate 411 of the product display shelf 410. For example, a torque sensor, an acceleration sensor, an inertial measurement unit (IMU), a motor input current sensor, etc. can be used as the contact detection sensor 30.

For example, a strain gauge can be used as a torque sensor to detect the torque generated in the shaft of each joint of the arm unit 20. Various types of acceleration sensors, such as capacitance type or piezoresistive type, mounted on the holder unit 10 or the arm unit 20 can be used as the acceleration sensors.

The inertial measurement unit (IMU) is a device which detects three-dimensional inertial motion (translational and rotational motion in three orthogonal axes), and the inertial measurement unit (IMU) is equipped with an acceleration sensor to detect translational motion and an angular velocity (gyro) sensor to detect rotational motion. Among these sensors, the gyro sensor can be used to detect angular velocity to obtain the angle or angular change of the target object. For example, in the case where gears or gears and toothed belts are used as drive transmission means for the wrist portion of the holder unit 10, the motion of the wrist portion of the holder unit 10 can have redundancy due to play between gears or stretching of the toothed belt. So, for example, during the operation of placing the product T held by the holder unit 10 on the shelf plate 411 of the product display shelf 410, in the state where the product T is in contact with the upper surface of the shelf plate 411, if an additional force is applied to the holder unit 10 by moving the arm unit 20 further, as a result, some displacement will be caused in the wrist portion of the holder unit 10, and the posture (i.e., angle) of the holder unit 10 changes. Therefore, such angular changes which may occur in the holder unit 10 during the operation of placing the product T on the shelf plate 411 can be detected by the IMU mounted on the holder unit 10 to detect that the product T has come into contact with the shelf plate 411.

In the case where a servomotor etc. is used to drive each joint of the arm unit 20, when an external force which causes an angle deviation from the angle at which the holding posture is maintained occurs, the servomotor operates to keep the angle deviation at zero in order to maintain the original angle. In the state where the product T held by the holder unit 10, the holder unit 10 or the arm unit 20 is in contact with an obstacle, such as a wall or a pillar of the product display shelf 410, at the time of moving the arm unit 20 further, current is input to the servomotor to drive the servomotor in opposition to the load. Therefore, by detecting the current inputted to the servomotor for such operation using the motor input current sensor, it is possible to detect that the product T held by the holder unit 10, the holder unit 10 or the arm unit 20 is in contact with an obstacle such as the wall or the pillar of the product display shelf 410. For example, the motor input current sensor may be in the form of a control unit 151 (see FIG. 5) described later.

Two first cameras 50R, 50L are provided on both of the left and right sides of the arm unit 20, respectively. The first cameral 50L mounted on the first side surface 23a which is the left side of the arm unit 20 is oriented in a first orientation A1 along a direction perpendicular to the extension direction of the arm unit 20 (see FIG. 4). The first camera 50L is used for mainly capturing an image of the product display shelf 410. The first camera 50R mounted on a second side surface 23b which is the right side of the arm unit 20 in parallel to the first side surface 23a and opposite to the first side surface 23a is oriented in a second orientation A2 which is opposite to the first orientation A1. The first camera 50R is used for mainly capturing an image of the stock shelf 420. As described above, the first cameras 50R, 50L are disposed in opposite directions to each other. Therefore, while keeping the arm unit 20 in the same posture, it is possible to capture images of the product display shelf 410 and the stock shelf 420 by the first cameras 50R, 50L, respectively, at the same time.

The performance of the first camera 50R and the performance of the first camera 50L may be the same, or may be different. Hereinafter, for the purpose of brevity of description, an example where both of the cameras have the same performance will be described. It should be noted that the purpose and/or the condition of capturing the image of the product display shelf 410 and the purpose and/or the condition of capturing the image of the stock shelf 420 are different. Therefore, it is a matter of course that cameras having different performances may be used depending on the respective purposes and conditions.

For example, the first cameras 50R, 50L may have an image capture element and a depth sensor. The image capture element generates a capture image (RGB image in one example) in which pixels are arranged in two dimensions. The depth sensor is a distance detection device for generating distance data. The depth sensor is not limited to a certain type as long as the depth sensor is capable of obtaining data of the distance to the target object. For example, the depth sensor may use a stereo lens system or a LiDAR (Light Detection and Ranging) system. For example, the depth sensor may generate Depth images. In other embodiments of the present disclosure, either or both of the first cameras 50R, 50L may, for example, utilize an ultrasonic element to obtain the distance data.

It should be noted that the first camera 50L is oriented in the first orientation A1. This means that the image capture direction of the image capture element and the depth sensor of the first camera 50L is the orientation A1. Likewise, the second camera 60 is oriented in the second orientation A2. This means that the image capture direction of the image capture element and the depth sensor of the first camera 50R is in the orientation A2. The orientations A1 and A2 do not necessarily have to be 180° opposites to each other, as long as the orientations A1 and A2 allow image capturing of the product display shelf 410 and the stock shelf 420.

One or both of the first cameras 50L, 50R may be provided on the holder unit 10. The first cameras 50L, 50R may not necessarily be provided on the same member. For example, the first camera 50R may be mounted on one of the link members 21 to 23, and the first camera 50L may be mounted on another one of the link members 21 to 23. However, in the case where the first cameras 50L, 50R are provided on the same member, in comparison with the case where the cameras 50L, 50R are provided on separate link members, respectively, there is an advantage that image processing computation is simplified because a common coordinate system is used.

The second camera 60 is used to capture an image showing the state where the holder unit 10 holds the product T, and the positional relationship between the product T held by the holder unit 10 and the shelf plate 411 of the product display shelf 410. As in the case of the first cameras 50R, 50L, the second camera 60 may have an image capture element and a depth sensor. The image capture element generates a capture image (RGB image in one example) in which pixels are arranged in two dimensions. The depth sensor generates distance data.

For example, the second camera 60 may be provided below the link member 23 closest to the holder unit 10, among the link members 21 to 23 of the arm unit 20, at a position close to the holder unit 10. The image capturing direction of the imaging element and the depth sensor of the second camera 60 are oriented directly downward (in the −z direction in FIGS. 3 and 4) or downward forward (somewhat more +x direction than in the −z direction in FIGS. 3 and 4) of the link member 23 and the holder unit 10. In the structure, the second camera 60 can capture at least a lower portion of the product T held by the holder unit 10 and the shelf plate 411 positioned on the front side of the holder unit 10.

The third camera 70 is a camera for capturing an image of a predetermined target object by changing the orientation, e.g., in accordance with operation of an operator at a remote location. For example, the third camera 70 is mounted on part of the elevation mechanism 90. The third camera 70 is capable of moving horizontally and vertically in a space between the product display shelf 410 and the stock shelf 420, in accordance with operation of the horizontal movement mechanism 80 and the elevation mechanism 90. Further, the portion of the elevation mechanism 90 on which the third camera 70 is mounted is rotatable about a pillar 95, and the third camera 70 is configured to rotate and move left and right about the pillar 95 as the portion rotates, and capture the image of the product display shelf 410 and capture the image of the stock shelf 420 as necessary.

For example, the third camera 70 may adopt a stereo lens system. Although not limited, the third camera 70 may have a wide angle of view in comparison with the first cameras 50L, 50R and the second camera 60.

The horizontal movement mechanism 80 has a base plate 81 and a drive mechanism (not shown). The base plate 81 supports the elevation mechanism 90, and slides along a rail (not shown) provided between the product display shelf 410 and the stock shelf 420 in the store. The drive mechanism (not shown) includes a motor, a roller, etc., and operates based on a control signal from the control device 150 (see FIG. 5) to move the elevation mechanism 90 to a predetermined position along the rail.

The elevation mechanism 90 has the pillar 95, a first elevation mechanism 91, and a second elevation mechanism 92. The pillar 95 is fixed on the base plate 81 and extends in the vertical direction.

The first elevation mechanism 91 has a drive mechanism (not shown). The drive mechanism (not shown) includes a motor and a linear guide, and operates based on a control signal from the control device 150 (see FIG. 5). By operating the drive mechanism (not shown), the first elevation mechanism 91 moves vertically up and down along the pillar 95. The upper portion of the first elevation mechanism 91, to which the third camera 70 is attached, is configured to be driven to rotate in the left-right direction about the pillar 95.

The second elevation mechanism 92 is held by the first elevation mechanism 91. One end of the arm unit 20 is attached to the second elevation mechanism 92. The second elevation mechanism 92 has a drive mechanism (not shown). The drive mechanism (not shown) includes a motor, a linear guide, etc., and operates based on a control signal from the control device 150 (see FIG. 5). By operating the drive mechanism (not shown), the second elevation mechanism 92 also moves vertically up and down.

In the case of holding a product T which is present at a predetermined height, the elevation mechanism 90 moves the arm unit 20 and the holder unit 10 by the first elevation mechanism 91 to a height around which the product T can be held, and finely adjusts the height of the arm unit 20 and the holder unit 10 by the second elevation mechanism 92.

In the present embodiment, the first elevation mechanism 91 and the second elevation mechanism 92 are provided as elevation mechanisms. However, in other embodiments of the present disclosure, only one elevation mechanism may be provided.

### <Structure of the Control Device 150>

As shown in FIG. 5, the control device 150 has the control unit 151, a memory unit 160, an input unit 191, an output unit 193, and a communication unit 195. In FIG. 5, though the control device 150 is drawn as a single element, the control device 150 does not necessarily have to be a physically single element, but may be composed of a plurality of elements that are physically separated from each other.

The input unit 191 is a device for receiving input from the operator. The input unit 191 may be made up of devices such as a keyboard, a mouse, a touch panel, etc. for providing input to a computer. The input unit 191 may have an audio input device such as a microphone. The input unit 191 may have a gesture input device which recognizes and identifies operator's movements through image recognition.

The output unit 193 is used for allowing the product transfer apparatus 1 to output an alert to a store employee, etc. For example, the output unit 193 is made up of one of, or a combination of devices such as a speaker, a display, a light-emitting deice, and a vibration device. The communication unit 195 has a function of receiving data from the outside and transmitting data to the outside. In the case where the product transfer apparatus 1 is configured to be operated remotely, an input from the operator through an operation unit of an external device (not shown) is received by the communication unit 195, and the control device 150 allows the product transfer apparatus 1 to perform a predetermined operation based on the input. Communication between the operation unit of the external device and the communication unit 195 may be either wired communication or wireless communication.

In the case where the product transfer apparatus 1 is configured to be operated remotely, the input unit 191 may be a device worn by the operator. The device includes a display device (not shown) and an operation device (not shown). The display device has a display which is visible to the operator. For example, the display device may be a head mount display (HMD). For example, the operation device may include one or more input sensors which can detect movement of the operator's body parts (e.g., hands and arms).

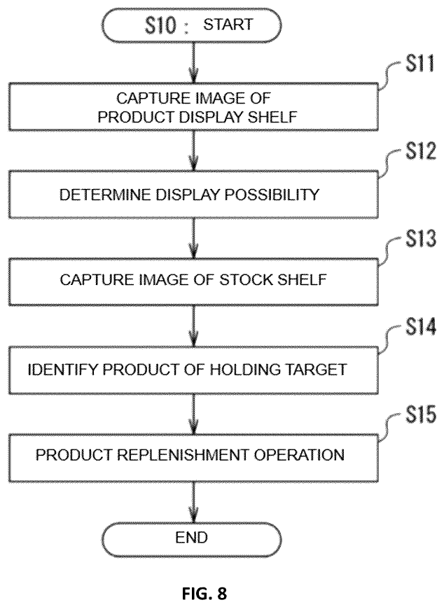

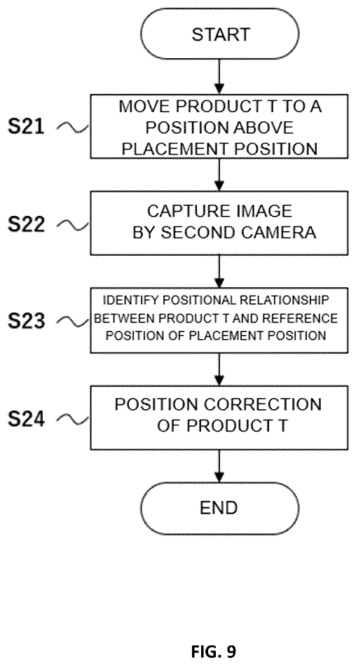

The memory unit 160 includes a transitory or non-transitory storage medium such as a ROM (Read Only Memory), a RAM (Random Access Memory) and a HDD (Hard Disk Drive). The memory unit 160 stores computer programs executed by the control unit 151, and/or learned models, etc., which will be described later. The computer programs stored in the memory unit 160 includes an instruction for performing a method of controlling the product transfer apparatus 1 by the control unit 151, which will be described later with reference to FIGS. 8 and 9, etc.

The memory unit 160 includes an acquisition data memory unit 160a and a reference data memory unit 160b. The acquisition data memory unit 160a stores capture image data, etc. captured by each of the cameras 50R, 50L, 60, 70. The reference data memory unit 160b stores various items of data necessary for operation of the product transfer apparatus 1. The various items of data include data regarding the product display shelf 410 and the stock shelf 420 (various items of shape data, position data, or lane coordinate data, etc.), and data regarding the product T (shape data, position data, etc.). In the present embodiment, the data regarding the distance between the central position of each lane of each shelf plate 411 of the product display shelf 410 and the left and right partition plates 412 is stored in the reference data memory unit 160b.

The control unit 151 is made up of one, or two or more CPUs (Central Processing Unit). The control unit 151 functions as an operation control unit 152, an image capture control unit 153, and an image data processing unit 155 by executing a computer program stored in the memory unit 160.

The operation control unit 152 generates control signals for operating each of the holder unit 10, the arm unit 20, the horizontal movement mechanism 80, the elevation mechanism 90, and the control device 150. The operation control unit 152 generates the control signals with reference to input signals from the input unit 191 and/or various items of data stored in the memory unit 160. Generation of the control signal may be performed by using the processing results of the image data processing unit 155. The operation control unit 152 transmits/receives data via the communication unit 195, and generates a predetermined output via the output unit 193.

The image capture control unit 153 controls operation of each of the cameras 50R, 50L, 60, 70. The image capture timing, etc. of each of the cameras 50R, 50L, 60, 70 may be determined using data stored in the reference data memory unit 160b in advance.

The image data processing unit 155 performs various items of information processing using capture image data and the distance data (depth data) captured by image capturing by each of the cameras 50R, 50L, 60, 70. For example, the image data processing unit 155 analyzes an image of image data captured by the first camera 50R, and identifies the products arranged on the stock shelf 420. The image data processing unit 155 has a display possibility determination unit 155a, a holding target identification unit 155b, a lane identification unit 155c, and a product position identification unit 155d.

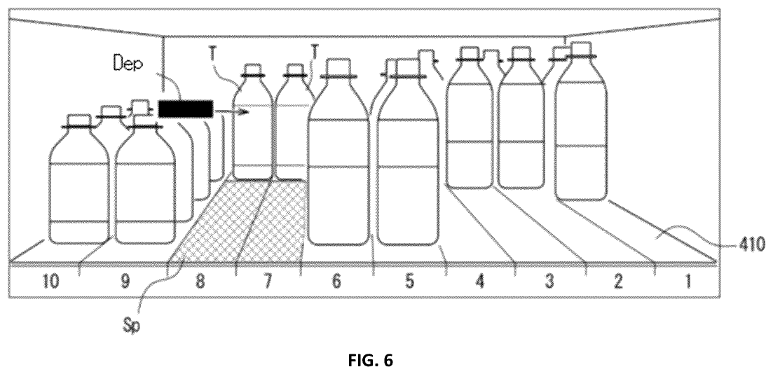

Based on at least one of the capture image data generated by image capturing of the first camera 50L and the distance data, the display possibility determination unit 155a determines, for example, whether or not a space Sp (see FIG. 6) is present to place more products behind the rearmost product T arranged on the product display shelf 410. FIG. 6 shows an image of the product display shelf 410 captured by the first camera 50L of the product transfer apparatus 1. If a space Sp is present, it means that the product T needs to be replenished. Therefore, if the space Sp is present, the display possibility determination unit 155a transmits a notification indicating that the product T should be replenished on the shelf plate 411 below the space Sp, to the operation control unit 152. In the case where the operation control unit 152 receives this notification, the operation control unit 152 performs replenishment operation for the product T.

Based on at least one of the capture image data captured by the first camera 50R and the distance data, the holding target identification unit 155b performs at least one of determination of whether or not the replenishment target product as a holding target is present in the stock shelf 420, identification of the size or shape of the replenishment target product, and determination of a holding position of the replenishment target product. In the case where the product T has the cap member Tb as shown in FIG. 1, for example, the holding target identification unit 155b sets a position near the cap member Tb as the holding position. In the case where the product T does not have the cap member Tb, the holding target identification unit 155b may set a side portion of the container as the holding position.

The lane identification unit 155c analyzes an image of the back side of the product display shelf 410 captured by the product transfer apparatus 1, and identifies the coordinate of each lane on the shelf plate 411 and the central position of each lane (central position in the width direction of each lane). Further, the lane identification unit 155c may identify the coordinate of the product T on the product display shelf 410. Further, the lane identification unit 155c may add an image of a dot, etc., at a position in the image corresponding to the identified coordinate.

The product position identification unit 155d analyzes image data of a capture image captured by the second camera 60 when the product T held by the holder unit 10 moves to a position above the product placement position (lane of the placement target) of the shelf plate 411 of the product display shelf 410, and identifies the positional relationship in a direction in which a plurality of lanes are arranged, between a reference position of the lane for placing the product of the shelf plate 411 and the product placed above the lane.

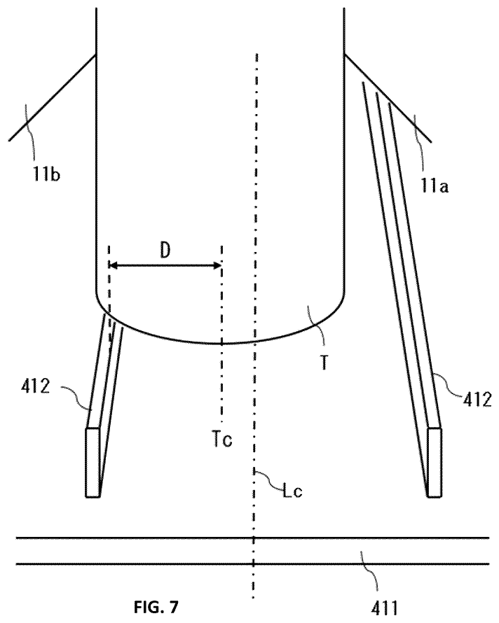

FIG. 7 is a view showing an example of a capture image captured when the product T held by the holder unit 10 is moved to a position above a product placement position of the shelf plate 411 of the product display shelf 410. As shown in FIG. 7, for example, based on the contour shape of the lower portion of the product T which appears in the capture image, the product position identification unit 155d generates a product central line Tc passing through the substantially center of the bottom surface of the product T held by the holder unit 10 and extending in the extension direction of the holder unit 10 and the arm unit 20 (x-axis direction shown in FIGS. 3 and 4) on the captured image as the position of a predetermined portion of the product T. Generation of the product central line Tc can be performed, for example, by identifying the part of the contour shape of a lower portion of the product T which protrudes the most on the lower side, using an arbitrary image recognition technique, and generating a straight line passing through the part and extending in the x-axis direction in a coordinate system recognized in advance by the product transfer apparatus 1.

Further, the product position identification unit 155d identifies the position of the partition plate 412 of the shelf plate 411 which appears on the capture image as a reference position by an arbitrary image recognition technique. Based on the product central line Tc generated as described above on the capture image and the identified partition plate 412, the product position identification unit 155d determines the distance D in the lateral direction (y-axis direction shown by FIGS. 3 and 4) between the partition plate 412 on the shelf plate 411 and the product central line Tc. In the case where the partition plates 412 are present on both of the left and right sides of the product central line Tc in the capture image, the product position identification unit 155d determines the distance D to at least one of the left and right partition plates 412. The distance between the central position of each lane on the shelf plate 411 and the left and right partition plates 412 is stored in the reference data memory unit 160b, and known in the system of the product transfer apparatus 1. Therefore, the product position identification unit 155d compares the distance D between the product central line Tc determined as described above and the partition plate 412 of the lane of the display target on the shelf plate 411 with the distance between the central position of the lane and the partition plate 412 stored in the reference data memory unit 160b. In this manner, it becomes possible to identify the distance by which the product central line Tc deviates from the central position of the lane in the left or right direction. Alternatively, the product position identification unit 155d may be configured to refer to the central position of the lane identified by the lane identification unit 155c (symbol Lc in FIG. 7), and uses the lane central position Lc as a reference position to directly compare the product central line Tc with the lane central position Lc and identify the distance by which the product central line Tc deviates from the above lane central position Lc in the left or right direction.

While an example of identifying and using the product central line Tc as the position of a predetermined portion of the product T is given above, the position of the product T which can also be used as the position of a predetermined portion of the product T in this embodiment is not limited to this example. For example, a position of one of both sides of the product T may be used as the position of the predetermined portion. Further, in the case where the distance (depth) data is also obtained by the second camera 60, the product position identification unit 155d may use the depth data for detection of positions of the product T, the shelf plate 411, and the partition plate 412.

Based on the above identification results, the operation control unit 152 moves the holder unit 10 as necessary so that the product T is placed at the correct product placement position on the shelf plate 411 (on the lane between the partition plates 412) without contacting the partition plates 412 to correct the position of the product T, and thereafter, operate the holder unit 10 to release the product T.

(Product Replenishment Operation by the Product Transfer Apparatus 1) FIG. 8 is a flow chart showing operation of replenishing the product T by the product transfer apparatus 1.

Firstly, in step S11, the first camera 50L mounted on the arm unit 20 of the product transfer apparatus 1 captures an image of the back side of the product display shelf 410. The product transfer apparatus 1 moves the arm unit 20, the horizontal movement mechanism 80, and the elevation mechanism 90 in a manner that an image of each level of the product display shelf 410 can be captured by the first camera 50L. Next, the product transfer apparatus 1 operates the first camera 50L to obtain an image of the back side of the product display shelf 410, and obtain the data of distance (distance data) to the product T arranged on the product display shelf 410.

Next, in step S12, display possibility determination is made. The “display possibility determination” is a step performed by the display possibility determination unit 155a in the image data processing unit 155 of the product transfer apparatus 1 to determine which products T can be displayed (in other words, which products T need to be replenished) on which shelf plate 411 by analyzing the captured image of the back side of the product display shelf. The product transfer apparatus 1 obtains the image of the back side of the product display shelf 410 as shown in FIG. 6.

The lane identification unit 155c in the image data processing unit 155 of the product transfer apparatus 1 identifies the lane on the shelf plate 411 of the product display shelf 410 using the capture image data captured by the first camera 50L. Further, since the image data processing unit 155 of the product transfer apparatus 1 can obtain data of the distance to the product T (depth data Dep visually shown in FIG. 6), it is possible to recognize the presence of a space Sp behind the product T for items such as the products T in lanes “7” and “8”, where the number of displayed products has been decreased. The product transfer apparatus 1 determines whether or not there is the space Sp for the product T based on the data of the distance to the product T, and whether or not more products T can be displayed in the lanes “7” and “8”. By the process of step S12, it is determined which products T need to be replenished on which shelf plate 411 of the product display shelf 410.

It should be noted that the method of determining whether or not products need to be replenished is not limited to the method described above, and various methods can be used. For example, it may be possible to determine what percentage of the products T are arranged in a given three-dimensional space and determine that the products T need to be replenished if the value is less than a predetermined standard value.

Next, in step S13, the image of the stock shelf 420 is captured. The product transfer apparatus 1 operates the arm unit 20, the horizontal movement mechanism 80, the elevation mechanism 90, and the first camera 50R to capture the image of the stock shelf 420 from the front side. For example, the product transfer apparatus 1 captures an image of the stock shelf 420 one level at a time, and obtains the capture image indicating the stock condition of the product T. It is not essential to perform image capturing of the stock shelf 420 after the image of the product display shelf 410 is captured, and image capturing of the stock shelf 420 may be performed before the image of the product display shelf 410 is captured.

Next, in step S14, the image data processing unit 155 of the product transfer apparatus 1 analyzes the image of the stock shelf 420 obtained in step S13 to identify the products arranged on the stock shelf 420. Further, the holding target identification unit 155b of the image data processing unit 155 identifies the holding position of the product. By the processes up to this point, information indicating which products T at which positions of which shelf plate 411 of the product display shelf 410 need to be replenished, information indicating the positions of the replenishment target products on the stock shelf 420 corresponding to the products T, and the holding positions of the replenishment target products are obtained by the product transfer apparatus 1.

Next, in step S15, the product transfer apparatus 1 performs product replenishment operation (pick-and-place operation) based on the above obtained information. Specifically, the operation control unit 152 of the control unit 151 of the product transfer apparatus 1 (see FIG. 5) operates the arm unit 20, the horizontal movement mechanism 80, and the elevation mechanism 90 to move the holder unit 10 toward a predetermined replenishment target product on the stock shelf 420. Then, the holder unit 10 holds the previously identified holding position of the replenishment target product, and, lifts the replenishment target product. Then, the operation control unit 152 operates the arm unit 20, the horizontal movement mechanism 80, and the elevation mechanism 90 to move the held product T to a predetermined placement position on the product display shelf 410, and releases the product T from the holder unit 10 to place the product T at a predetermined position. Thereafter, the product transfer apparatus 1 repeats the pick-and-place operation in the same manner to complete replenishment of the products T.

The above series of processes are the basic operations of the product transfer apparatus 1 for automatically replenishing the products T from the stock shelf 420 to the product display shelf 410. In the product replenishment operation (pick-and-place operation) in step S15 of the series of processes as described above, in the state where the bottom surface of the product T contacts the upper side of the partition plate 412, when operation to place the product T on the shelf plate 411 of the product display shelf 410 is performed, the product T may fall over or tilt obliquely, and display and/or replenishment of the other products T may be hindered. The present embodiment provides means for preventing contact of the product T with the partition plate 412 of the shelf plate 411 in the product replenishment operation (pick-and-place-operation).

### First Operation Example

FIG. 9 is a flow chart showing a first operation example of the product transfer apparatus 1 of the present embodiment.

Firstly, in step S21, the operation control unit 152 of the control unit 151 of the product transfer apparatus 1 (see FIG. 5) operates the holder unit 10, the arm unit 20, the horizontal movement mechanism 80, and the elevation mechanism 90 to hold the product T as a target of replenishment in the stock shelf 420, and moves the product to a position above the placement position of the product display shelf 410. This step S21 corresponds to operation before the product T is released from the holder unit 10 in step S15 described above.

Next, in step S22, the image capture control unit 153 of the control unit 151 of the product transfer apparatus 1 (see FIG. 5) captures an image by the second camera 60. Thus, the capture image including at least the lower portion of the product T held by the holder unit 10 and the shelf plate 411 positioned below the product T, and the distance data are obtained by the second camera 60. The obtained capture image and the distance data are stored in the acquisition data memory unit 160a of the memory unit 160. As shown in FIG. 7, the capture image obtained by the second camera 60 includes at least the lower portion of the product T held by the holder unit 10 and the shelf plate 411 and the partition plate 412 positioned below the product T.

Next, in step S23, the product position identification unit 155d in the image data processing unit 155 of the product transfer apparatus 1 identifies the positional relationship between the product T positioned above the placement position (lane) on the shelf plate 411 and a reference position of the lane as the placement position. In the step S23, as described above with reference to FIG. 7, firstly, based on the contour shape of the lower portion of the product T shown in the capture image obtained by the second camera 60, the product position identification unit 155d generates a product central line Tc passing through the center of the bottom surface of the product T held by the holder unit 10, and extending in the extension direction of the holder unit 10 and the arm unit 20 (x-axis direction shown in FIGS. 3 and 4), on the capture image. As described above, for example, generation of the product central line Tc is performed by identifying the part of the contour shape of the lower portion of the product T which protrudes the most on the lower side, using an arbitrary image recognition technique, and generating a straight line passing through the part, and extending in the x-axis direction in the coordinate system recognized beforehand by the product transfer apparatus 1. Further, the product position identification unit 155d identifies a partition plate 412 on the shelf plate 411 shown in the captured image by an arbitrary image recognition technique.

Then, the product position identification unit 155d determines the distance D in the lateral direction (y-axis direction shown in FIGS. 3 and 4) between the partition plate 412 on the shelf plate 411 and the product central line Tc. In the case where the partition plate 412 is present on both of the left and right sides of the product central line Tc, the product position identification unit 155d determines the distance D to at least one of the left and right partition plates 412.

The distance between the center of each lane of the shelf plate 411 and the left and the right partition plates 412 is stored in the reference data memory unit 160b beforehand, and known in the system of the product transfer apparatus 1. Therefore, the product position identification unit 155d compares the distance D between the product central line Tc determined as described above and the partition plate 412 of the lane of the display target on the shelf plate 411 with the distance between the central position of the lane and the partition plate 412 stored in the reference data memory unit 160b. In this manner, the product position identification unit 155d can identify by which distance the product central line Tc deviates from the central position of the lane in the left or right direction. For example, in the case where the distance between the central position of the lane and the partition plate 412 stored in the reference data memory unit 160b is 30 mm, and the determined distance D is 20 mm, it is identified that the center of the product T deviates from the central position of the lane in a direction closer to the partition plate 412 by 10 mm, or in the case where the determined distance D is 35 mm, it is identified that the center of the product T deviates from the central position of the lane in a direction away from the partition plate 412 by 5 mm.

Lastly, in step S24, the operation control unit 152 of the product transfer apparatus 1 operates the holder unit 10, the arm unit 20, etc. to correct the positional displacement of the product T from the central position of the lane.

The operation control unit 152 operates the holder unit 10, the arm unit 20, etc., based on the positional relationship between the lane central position and the center of the product T identified by the product position identification unit 155d in step S23 in a manner that the product T is moved in the left-right direction (direction along the y-axis in FIGS. 3 and 4) until the center of the product T held by the holder unit 10 comes to the lane central position. For example, in the above example, in the case where it is identified that the product T deviates from the central position of the lane in a direction closer to the partition plate 412 by 20 mm, the product T is moved in a direction away from the partition plate by 20 mm, or in the case where it is identified that the product T deviates from the central position of the lane in a direction away from the partition plate 412 by 15 mm, the product T is moved in a direction closer to the partition plate 412 by 15 mm. In this manner, the central position of the product T is placed above the position which substantially matches the central position of the lane.

After this step S24, the operation control unit 152 of the product transfer apparatus 1 performs operation of releasing the product T from the holder unit 10, which is the final operation of the above step S15, and places the product T at a predetermined position (lane of the display target) on the shelf plate 411. In general, the width of each lane on the shelf plate 411 is larger than the lateral width of the product T of the display target. At the position where the center of the product T substantially matches the central position of the lane, since some gap space is provided reliably between the side surface of the product T and the partition plate 412, even if the product T is placed on the lane of the shelf plate 411 at the position, the bottom surface of the product T does not contact the partition plate 412. Therefore, in the above step S15, even in the case where the product T moved to a position above the display position of the shelf plate 411 deviates from a predetermined position, after performing correction operation of the placement position of the product T in step S24, by performing operation of releasing the product T from the holder unit 10 at the end of the step S15, it is possible to place the product T at the placement position of the shelf plate 411 (on the lane of the placement target) without falling over, etc. of the product T by contact with the partition plate 412.

In the above description, in step S15, in the case where the product T moved to a position above the placement position of the shelf plate 411 deviates from the predetermined position, in step S24, correction operation of the placement position of the product T is performed. However, this correction operation may be omitted depending on the deviation amount from the predetermined position. As described above, in general, the width of each lane on the shelf plate 411 is larger than the lateral width of the product T of the display target. Therefore, in the case where the deviation amount from the predetermined position of the product T is smaller than a predetermined distance, in the state, even if the product T is released from the holder unit 10 and placed on the shelf plate 411, it is possible to place (display) the product T on the predetermined lane on the shelf plate 411 without contact between the product T and the partition plate 412. The deviation amount which allows omission of the correction operation such as 3 mm, 5 mm can be set in advance in the operation control unit 152 of the product transfer apparatus 1. In the case where the deviation amount identified by the product position identification unit 155d is within the above predetermined distance, the operation control unit 152 may perform operation of releasing the product T from the holder unit 10 without performing position correction operation of the product T.

In step S24, at the time of operating the holder unit 10 and the arm unit 20, etc. for correcting the positional deviation of the product T from the central position of the lane, in some cases, the holder unit 10 or the arm unit 20 contacts the wall or the pillar of the product display shelf 410, and may result in a situation where the holder unit 10 and the arm unit 20, etc. cannot be moved any further. If the holder unit 10 and the arm unit 20 are attempted to be moved further to correct the position of the product T in such a situation, the product T, the holder unit 10 or the arm unit 20 may be damaged, or the wall or the pillar of the product display shelf 410 may be damaged. In the present embodiment, while the holder unit 10 and the arm unit 20, etc. are operated to correct the positional deviation of the product T, when the contact detection sensor 30 detects that the product T held by the holder unit 10, the holder unit 10 or the arm unit 20 contacts an obstacle such as the wall or the pillar of the product display shelf 410, the operation control unit 152 finishes the operation of the holder unit 10 and the arm unit 20, etc. for correcting the position of the product T and execute operation to release the product T from the holder unit 10. Thus, by further operating the holder unit 10 or the arm unit 20 in the state where the product T, the holder unit 10, or the arm unit 20 contacts an obstacle, it is possible to prevent damages of the product T, the holder unit 10, or the arm unit 20, or the wall, the pillar, etc. of the product display shelf 410. In this case, the product transfer apparatus 1 may send a notification indicating inability of the position correction operation from the communication unit 195 to the external device (not shown) used by an operator. The operator of the device who has received the notification can remotely operate the product transfer apparatus 1 using the external device, obtain image data from the second camera 60, check the position of the product T, and as necessary, remotely operate the holder unit 10 and the arm unit 20 etc. to correct the position, or take other actions.

Further, while the case where the partition plate 412 on the shelf plate 411 is used as the reference position for identifying the product position in step S23 has been described above, in the present embodiment, it is not essential to use the position of the partition plate 412 as a reference position for identifying the product position. For example, the product position identification unit 155d may use the central position Lc of each lane identified by the lane identification unit 155c of the image data processing unit 155 as the reference position for identifying the product position, and determine the distance between the central line Tc of the product T identified as described above and the central position Lc of the lane on which the product T is placed as the amount of positional deviation. In this case, the position correction operation of the product T is performed by the operation control unit 152 to correct the distance (amount of positional deviation) determined in this manner.

### Second Operation Example

In the above described first operation example, based on the image data captured by the second camera 60, the product identification unit 155d of the product transfer apparatus 1 identifies the positional relationship between the product T held by the holder unit 10 and the placement position in the lane on the shelf plate 411 on which the product T should be placed, and based on the identification result, the operation control unit 152 of the product transfer apparatus 1 operates the holder unit 10, and the arm unit 20, etc. to move the product T to a placement position in the lane on the shelf plate 411 so as to correct the position of the product T. Thereafter, the holder unit 10 release the product T to place the product T at the placement position. In contrast, in the second operation example, the product position identification unit 155d of the product transfer apparatus 1 provides means for identifying the positional relationship between the product held by the holder unit 10 and the placement position in the lane on the shelf plate 411 where the product T should be placed, using a learned model generated in machine learning by the product position identification unit 155d of the product transfer apparatus 1.

For example, the learned model used to identify the positional relationship between the product T and the placement position on the shelf plate 411 where the product T should be placed may be generated in machine learning by an arbitrary learning machine comprising a computer, using teaching data and learning data. The teaching data comprises various types of image data and/or depth data including the product T held by the holder unit 10 and the shelf plate 411 captured by the second camera 60 as described above, in the state where the product T is positioned above the placement position by the holder unit 10 and the arm unit 20 for allowing the holder unit 10 to place the product T on the placement position on the shelf plate 411, and annotation information regarding the positional relationship between the placement position on the shelf plate 411 and the product T associated with each data. The learning data is the image data and/or the depth data including the product T held by the holder unit 10 and the shelf plate 411.

Such a learned model can be generated, for example, by performing machine learning on a neural network comprising multiple layers including neurons in each layer. Deep neural networks, such as convolutional neural networks (CNN: Convolutional Neural Network) having 20 or more layers, may be used as such neural networks. The machine learning using such deep neural networks is referred to as deep learning. The learned model generated in this way is stored in the memory unit 160 of the product transfer apparatus 1 and implemented as a functional module of the product position identification unit 155d of the product transfer apparatus 1.

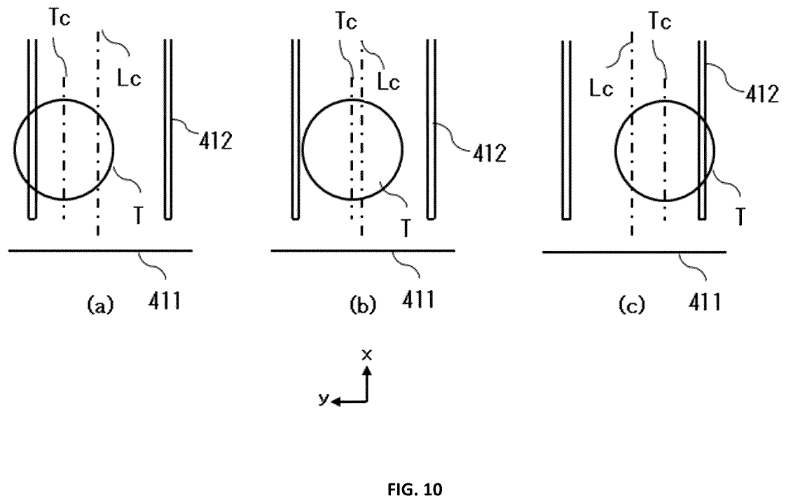

FIG. 10 is a conceptual view showing examples of various positional relationships between the product T held by the holder unit 10 and placed above the placement position before being placed on the placement position on the shelf plate 411 and the placement position on the shelf plate 411, as captured by the second camera 60 of the product transfer apparatus 1. In FIG. 10, a state where a contour of a surface around the bottom of the product T, and a partition plate 412 forming the placement position (lane) on the shelf plate 411 are projected from above is drawn schematically.

In FIG. 10(a), the central line Tc of the product T deviates from the central position Lc of the lane as the placement position on the shelf plate 411 by 15 mm toward the left side in the drawing (in the y-axis direction). The image data in the state shown in FIG. 10(a) is associated with “deviation direction: y-axis direction, deviation amount: 15 mm, left side contact”, as annotation information regarding the positional relationship of the product T with the placement position on the shelf plate 411, and used as teaching data. In FIG. 10(b), the central line Tc of the product T deviates from the central position of the lane as the placement position on the shelf plate 411 by 5 mm toward the left side in the drawing (in the y-axis direction), and the image data in the state shown in FIG. 10(b) is associated with “deviation direction: y-axis direction, deviation amount: 5 mm, no contact”, as annotation information regarding the positional relationship of the product T with the placement position on the shelf plate 411, and used as teaching data. Further, in FIG. 10(c), the central line Tc of the product T deviates from the central position Lc of the lane as the placement position on the shelf plate 411 by 10 mm toward the right side in the drawing (in the −y-axis direction), and the image data in the state shown in FIG. 10(c) is associated with “deviation direction: −y-axis direction, deviation amount: 10 mm, right side contact”, as annotation information regarding the positional relationship of the product T with the placement position on the shelf plate 411, and used as teaching data. As described above, teaching data is made up of a plurality of items of image data and/or depth data indicating various positional relationships between the product T placed above the placement position and the placement position on the shelf plate 411, and annotation information regarding the positional relationship between the placement position on the shelf plate 411 and the product T associated with each image data.

In this example, the product position identification unit 155d of the product transfer apparatus 1, in which the learned model described above is implemented as a functional module, instead of performing the process of step S23 described in the first operation example, identifies, using the learned model described above, for the image data captured by the second camera 60, the positional relationship between the product T placed above the placement position on the shelf plate 411 before being placed at the placement position on the shelf plate 411 and the placement position on the shelf plate 411. In this example, since the above positional relationship is identified using the learned model, compared to the case where the above positional relationship is identified from image data, etc. by executing the process using the image recognition technique as in the first operation example, it is possible to reduce the calculation cost, and increase the processing speed.

In the same manner as in step S24 described in the first operation example, based on the positional relationship between the lane central position Lc and the central line Tc of the product T identified as described above, the operation control unit 152 of the product transfer apparatus 1 in this example also operates the holder unit 10 and the arm unit 20, etc. to correct the positional deviation of the center of the product T relative to the lane center position Lc, and moves the product T in the left-right direction (along the y-axis in FIGS. 3 and 4) until the center of the product T held by the holder unit 10 is positioned at the lane central position. Then, the operation control unit 152 of the product transfer apparatus 1 executes the operation of releasing the product T from the holder unit 10 and places the product T at a predetermined position on the shelf plate 411 (lane of the display target).

As a modified example of the second operation example, the product position identification unit 155d of the product transfer apparatus 1 may be configured to identify the positional relationship between the product T placed above the placement position before being placed on the placement position on the shelf plate 411 and the placement position on the shelf plate 411 according to the magnitude of the probability value generated as a result of performing the process using the learned model described above.

For example, for the image data captured by the second camera 60, the product position identification unit 155d uses the above learned model to determine, as the position of the product T placed above the placement position before being placed on the placement position on the shelf plate, the occurrence probability values regarding the three states of: (1) the central area of the lane at the placement position (no contact with the partition plate 412), (2) contact with the partition plate 412 on the left side of the screen of the lane, and (3) contact with the partition plate 412 on the right side of the screen of the lane. The product position identification unit 155d adopts the state having the largest occurrence probability value among the obtained occurrence probability values regarding the three states as the position of the product T in the image data of the processing target.

In accordance with the position correction operation content associated in advance with each state of the position of the product T and the occurrence probability value, the operation control unit 152 of the product transfer apparatus 1, operate the holder unit 10 and the arm unit 20, etc. to correct the positional deviation of the center of the product T relative to the central position Lc of the lane, and move the product T in the left-right direction (along the y-axis in FIGS. 3 and 4) until the center of the product T held by the holder unit 10 is positioned at the center of the lane. Then, the operation control unit 152 of the product transfer apparatus 1 performs operation of releasing the product T from the holder unit 10, and places the product T at a predetermined position (lane of the display target) on the shelf plate 411.

Table 1 below shows an example of a look-up table which associates each state of the position of the product T and the occurrence probability value with the contents of the position correction operation. This lookup table is stored beforehand in the memory unit 160 of the product transfer apparatus 1.

TABLE 1

| Occurrence | | (2) Contact with partition plate | (2) Contact with partition plate |
|---|---|---|---|
| probability value | (1) Central area | on the left side of lane | on the left side of lane |
| 0.9~1. 0 | No position correction | Move 15 mm to the right | Move 15 mm to the left |
| 0.8~less than 0.9 | No position correction | Move 10 mm to the right | Move 10 mm to the left |
| 0.7~less than 0.8 | No position correction | Move 5 mm to the right | Move 5 mm to the left |
| 0.6~less than 0.7 | No position correction | Move 3 mm to the right | Move 3 mm to the left |
| less than 0.6 | Notify operator | Notify operator | Notify operator |

The above example will be explained below. For example, it is assumed that the state with the largest value among the occurrence probability values for the three states is “(1) Central area” and the occurrence probability values are 0.9 to 1.0, 0.8 to less than 0.9, 0.7 to less than 0.8, and 0.6 to less than 0.7. The product T is at substantially the central position of the predetermined position on the shelf plate 411 (lane of the display target) and the probability that the product T is not in contact with either the left or right partition plate 412 of the product T is 60% or more. Therefore, the position correction operation content is set to “No position correction”. So, if these conditions are satisfied, the position correction operation of the product T by the operation control unit 152 is not performed, and the operation of releasing the product T from the holder unit 10 at the position is performed and the product T is placed at a predetermined position (lane for display target) on the shelf plate 411.

Further, in the case where the state with the largest value among the occurrence probability values for the three states is “(2) Contact with the partition plate on the left side of the lane”, the movement distance for the position correction of the product T is set in accordance with the occurrence probability value. In the case where the occurrence probability value is 0.9 to 1.0, which is the largest, since the product T is likely to be positioned above the partition plate closer to the left side of the lane, the movement distance to the center of the lane is set to “15 mm to the right”, which is relatively large. As the occurrence probability values get smaller, such as 0.8 to less than 0.9, 0.7 to less than 0.8 and 0.6 to less than 0.7, since the product T becomes less likely to be positioned above the partition plate closer to the left side of the lane, i.e., since the product T becomes more likely to be placed on the central side of the lane, the movement distance to the center of the lane associated with these occurrence probability values is set successively smaller, such as 10 mm, 5 mm, 3 mm, etc. Also, in the case where the state with the largest value among the occurrence probability values for the three states is “(3) Contact with the partition plate on the right side of the lane”, the setting is made in the same manner, but the movement direction for position correction of the product T becomes the opposite “left direction”.

It should be noted that, in the case where the state with the largest value among the occurrence probability values for the three states is less than 0.6, since the position of product T may not have been correctly identified because the accuracy of identifying the position of product T is relatively low, the product transfer apparatus 1 sends a notification indicating the inability to identify the position from the communication unit 195 to an external device (not shown) used by the operator. Upon receiving the notification, the operator of the device can remotely operate the product transfer apparatus 1 using the external device, obtain image data from the second camera 60 to check the position of the product T, and remotely operate the holder unit 10 and the arm unit 20, etc. to correct the position as necessary, or take other actions.

Otherwise, even in the case where the occurrence probability values for all three states are 0.6 or more, if the occurrence probability values are all relatively low, and close to each other, such as for example (1) “Central area” is 0.7, (2) “Contact with the partition plate on the left side of the lane” is 0.6, and (3) “Contact with the partition plate on the right side of the lane” is 0.7, it is difficult to identify the position state of the product T. Therefore, also in such cases, the product transfer apparatus 1 may also send a notification indicating inability to identify the position, from the communication unit 195 to the external device (not shown) used by the operator. On the other hand, even in the case where the occurrence probability values for all three states are less than 0.6, if the differences between the largest value and the other values are large, such as for example (1) “Central area” is 0.5, (2) “Contact with the partition plate on the left side of the lane” is 0.001, and (3) “Contact with the partition plate on the right side of the lane” is 0.001, the product position identification unit 155d may adopt the state of the largest value as the position state of the product T. It is possible, as necessary, to determine the criteria where notification indicating inability to identify the position even if all of the occurrence probability values are not less than 0.6 (for example, all of the occurrence probability values regarding the three states are within the error range of 10%, etc.) as in the former case, and/or the criteria where the state of the largest value is adopted as the position state of the product T even if all of the occurrence probability value is less than 0.6 (for example, the largest occurrence probability value is 10 times or more larger than the other occurrence probability values) as in the latter case.

Each of the ranges of the occurrence probability values and the position correction operations and the movement distances associated with these values are not limited to the examples described in Table 1, but can be determined as necessary according to the details of the implementation.

While the present disclosure has been described though embodiments of the invention, the embodiments are not intended to limit the scope of the invention as claimed. Further, any form of combination of the features described in the embodiments of the present disclosure may also be included in the technical scope of the invention. Furthermore, it is also apparent to those skilled in the art that various modifications or improvements can be made to the embodiments described above.

1. A product transfer apparatus configured to move a product placed on a stock shelf to a product display shelf which is different from the stock shelf,
the product transfer apparatus comprising:
an arm unit having a holder unit configured to hold the product;
an image capture unit configured to obtain image data including at least a portion of the product held by the holder unit for placing the product on one of a plurality of lanes provided on a shelf plate of the product display shelf for displaying the product and placed above the one of the lanes by the arm unit, and at least a portion of the shelf plate including a position of the one of the lanes; and
a control unit configured to control operation of the holder unit, the arm unit, and the image capture unit,
wherein the control unit is configured to perform:
identifying, based on the image data, a positional relationship in a direction in which the plurality of lanes are arranged, between a reference position of the lane of the shelf plate on which the product is to be placed and the product placed above the lane; and
correcting, based on the identified positional relationship, the position of the product relative to the reference position by operating the arm unit.

2. The product transfer apparatus according to claim 1, wherein the identifying the positional relationship includes identifying a central position of the lane as the reference position by analyzing the image data.

3. The product transfer apparatus according to claim 1, wherein the shelf plate is provided with a partition member for dividing the plurality of lanes; and
the identifying the positional relationship includes identifying a position of the partition member as the reference position by analyzing the image data.

4. The product transfer apparatus according to claim 1, wherein the identifying the positional relationship includes identifying a position of a predetermined portion of the product by analyzing the image data.

5. The product transfer apparatus according to claim 1, wherein the identifying the positional relationship includes identifying the positional relationship using a learned model generated by machine learning beforehand using teaching data and learning data; and
the teaching data comprises various types of image data and annotation information regarding the positional relationship between the product and the reference position associated respectively with the various types of image data, and the learning data comprises various types of image data which are different from the various types of image data of the teaching data.

6. The product transfer apparatus according to claim 5, wherein the correcting the position of the product relative to the reference position includes moving the product by a distance associated beforehand with a probability value regarding the positional relationship identified using the learned model.

7. The product transfer apparatus according to claim 1, wherein the product transfer apparatus further comprises a contact detection sensor configured to detect contact of the product held by the holder unit, the holder unit, or the arm unit with an obstacle; and
the control unit is configured to finish operation of the arm unit, of correcting the position of the product relative to the reference position when the contact detection sensor detects contact of the product held by the holder unit, the holder unit, or the arm unit with the obstacle while the arm unit is operated to correct the position of the product relative to the reference position.

8. A method of controlling a product transfer apparatus for moving a product placed on a stock shelf to a product display shelf which is different from the stock shelf,
wherein the product transfer apparatus comprises:
an arm unit having a holder unit configured to hold the product;
an image capture unit configured to obtain image data including at least a portion of the product held by the holder unit for placing the product on one of a plurality of lanes provided on a shelf plate of the product display shelf for displaying the product and placed above the one of the lanes by the arm unit, and at least a portion of the shelf plate including a position of the one of the lanes; and
a control unit configured to control operation of the holder unit, the arm unit, and the image capture unit, and
wherein the method is performed by the control unit and including:
identifying, based on the image data, a positional relationship in a direction in which the plurality of lanes are arranged, between a reference position of the lane of the shelf plate on which the product is to be placed and the product placed above the lane; and
correcting, based on the identified positional relationship, the position of the product relative to the reference position by operating the arm unit.

9. A non-transitory computer-readable storage medium storing a computer program, the computer program when executed by one or more processors, configures the one or more processors to control a product transfer apparatus to move a product placed on a stock shelf to a product display shelf which is different from the stock shelf,
the product transfer apparatus comprising:
an arm unit having a holder unit configured to hold the product;
an image capture unit configured to obtain image data including at least a portion of the product held by the holder unit for placing the product on one of a plurality of lanes provided on a shelf plate of the product display shelf for displaying the product and placed above the one of the lanes by the arm unit, and at least a portion of the shelf plate including a position of the one of the lanes; and
a control unit configured to control operation of the holder unit, the arm unit, and the image capture unit,
wherein the program allows the control unit to perform:
identifying, based on the image data, a positional relationship in a direction in which the plurality of lanes are arranged, between a reference position of the lane of the shelf plate on which the product is to be placed and the product placed above the lane; and
correcting, based on the identified positional relationship, the position of the product relative to the reference position by operating the arm unit.
